(19) United States
(12) Patent Application Publication
(10) Pub. No.: US 2017/0052360 A1
(43) Pub. Date: Feb. 23, 2017

(54) Illumination device for Magnifier

(71) Applicant: GEM Optical Co., Ltd., Taichung (TW)

(72) Inventor: Yen-Hung Huang, TAICHUNG CITY (TW)

(21) Appl. No.: 14/833,097

(22) Filed: Aug. 23, 2015

(51) Int. Cl. G02B 25/02; F21V 23/06; F21V 23/00; F21V 23/04; F21L 4/02; F21V 17/12

(52) U.S. Cl. CPC G02B 25/02; F21L 4/02; F21V 17/12; F21V 23/002; F21V 23/0428; F21V 23/06

(57) ABSTRACT

An illumination device for a magnifier contains: a body, a light emitting assembly, a battery assembly, an electricity conducting sleeve, a cover, and an electric disc. The light emitting assembly includes plural LED elements, each having a first electricity contact point and a second electricity contact point. The battery assembly includes a first electrode connecting with the first electricity contact point of the light emitting assembly and includes a second electrode. The electricity conducting sleeve fits with the body and is electrically connected with the second electrode, and the electricity conducting sleeve includes a rib extending out of the body. The cover is joined with the body, and the electric disc includes a first electric transmitting portion for contacting with the second electrode and includes plural second electric transmitting portions arranged around the first electric transmitting portion to contact with the rib of the electricity conducting sleeve.

### FIELD OF THE INVENTION

The present invention relates to an illumination device for a magnifier in which the plural second electric transmitting portions of the electric disc contact with the rib of the electricity conducting sleeve to avoid power failure and a damage of the electricity conducting sleeve.

### BACKGROUND OF THE INVENTION

Referring to FIGS. 1 and 2, a conventional illumination device 10 contains a body 11, a light emitting assembly 12 arranged on a front end of the body 11, a battery 13 accommodated in the body 11 and including a first electrode 131 and a second electrode 132, a power switch 14 electrically connected with the first electrode 131 of the battery 13 and a first electricity contact point of the light emitting assembly 12, and an electric guiding piece 15 fixed in the body 11, wherein a front end of the electric guiding piece 15 is electrically connected with a second electricity contact point of the light emitting assembly 12 via the power switch 14, and a rear end of the electric guiding piece 15 has a bent portion 15 to hook with a rear end of the body 11. The body 11 includes a cover 16 connected on the rear end thereof, and a conducting spring 17 is accommodated in the cover 16 to abut against the second electrode 132 of the battery 13 and the bent portion 151 of the electric guiding piece 15, such that the power switch 14 is turned on to emit lights from the light emitting assembly 12. However, the illumination device 10 has defects as follows:

1. The bent portion 151 of the electric guiding piece 15 abuts against the conducting spring 17 on a single contact point, so when the bent portion 151 causes corrosion or the cover 16 connects on the rear end of the body 11 repeatedly, the bent portion 151 is broken often.

2. The conducting spring 17 is accommodated in the cover 16 after being pressed into the cover 16, so it removes from the cover 16 easily.

The present invention has arisen to mitigate and/or obviate the afore-described disadvantages.

### SUMMARY OF THE INVENTION

The primary objective of the present invention is to provide an illumination device for a magnifier in which the plural second electric transmitting portions of the electric disc contact with the rib of the electricity conducting sleeve to avoid power failure and a damage of the electricity conducting sleeve.

To obtain above-mentioned objective, an illumination device for a magnifier provided by the present invention contains a body, a light emitting assembly, a battery assembly, an electricity conducting sleeve, a cover, and an electric disc.

The light emitting assembly is connected with a front end of the body and includes plural LED elements arranged therein, and each of the plural LED elements has a first electricity contact point and a second electricity contact point.

The battery assembly is accommodated in the body and includes a first electrode and a second electrode, the first electrode electrically connects with the first electricity contact point of the light emitting assembly.

The electricity conducting sleeve fits with a rear end of the body and is electrically connected with the second electrode of the light emitting assembly, and the electricity conducting sleeve includes a rib extending out of the rear end of the body.

The cover is joined with the rear end of the body.

The electric disc is received in the cover and includes a first electric transmitting portion for contacting with the second electrode of the battery assembly. The electric disc also includes plural second electric transmitting portions arranged around the first electric transmitting portion to contact with the rib of the electricity conducting sleeve.

### BRIEF DESCRIPTION OF THE DRAWINGS

FIG. 1 is a perspective view showing the exploded components of a conventional illumination device.

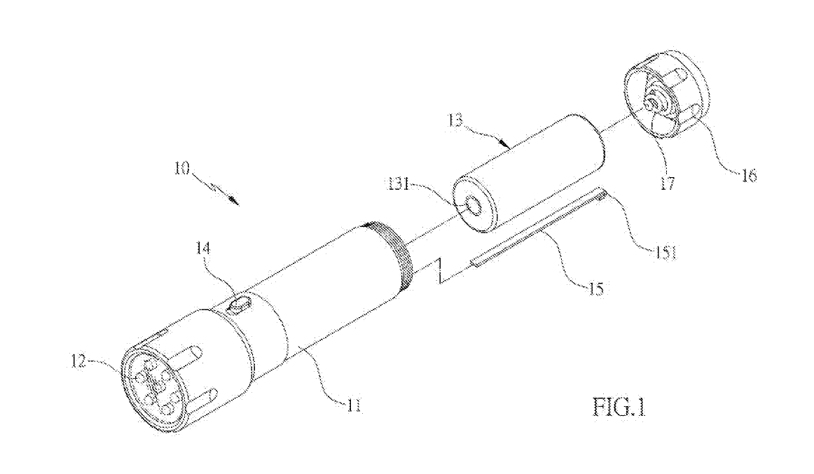

FIG. 2 is a cross sectional view showing the assembly of the conventional illumination device

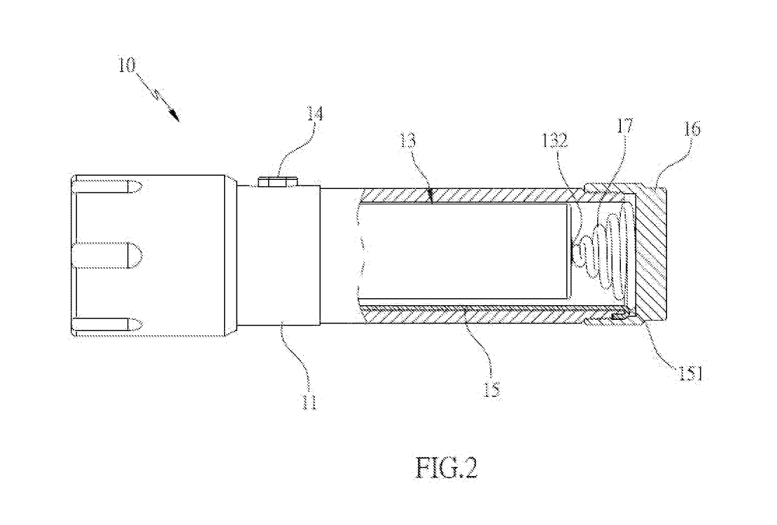

FIG. 3 is a perspective view showing the exploded components of an illumination device for a magnifier according to a preferred embodiment of the present invention.

FIG. 4 is a cross-sectional perspective view showing the operation of a part of the illumination device for the magnifier according to the preferred embodiment of the present invention.

FIG. 5 is a perspective view showing the assembly of the illumination device for the magnifier according to the preferred embodiment of the present invention.

FIG. 6 is a cross sectional view showing the assembly of the illumination device for the magnifier according to the preferred embodiment of the present invention.

FIG. 7 is an amplified cross sectional view of a portion A of FIG. 6.

FIG. 8 is a cross sectional view showing the operation of the illumination device for the magnifier according to the preferred embodiment of the present invention.

### DETAILED DESCRIPTION OF THE PREFERRED EMBODIMENTS

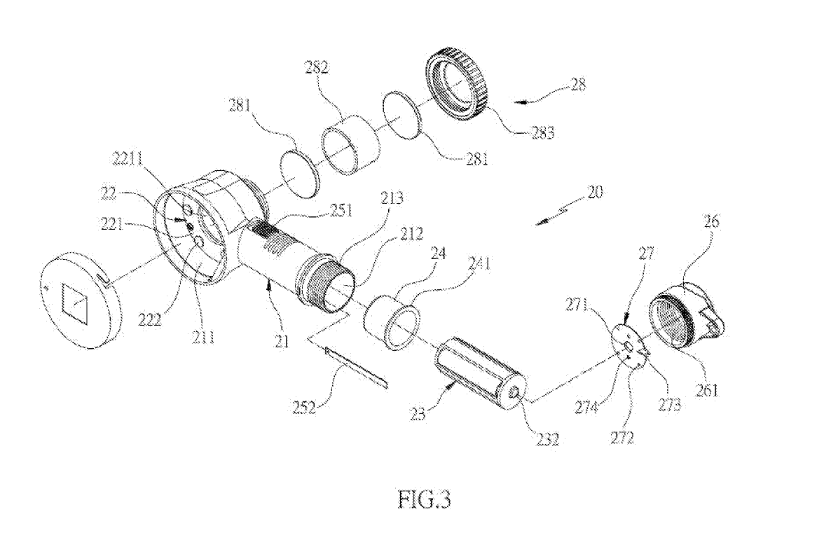

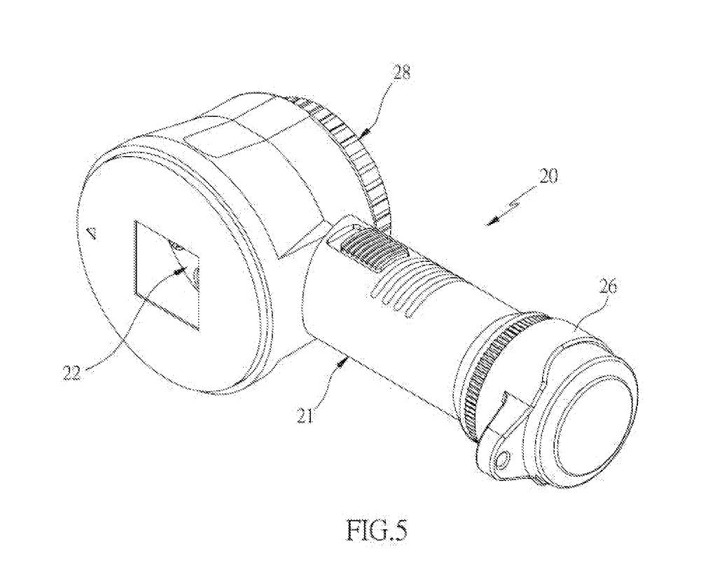

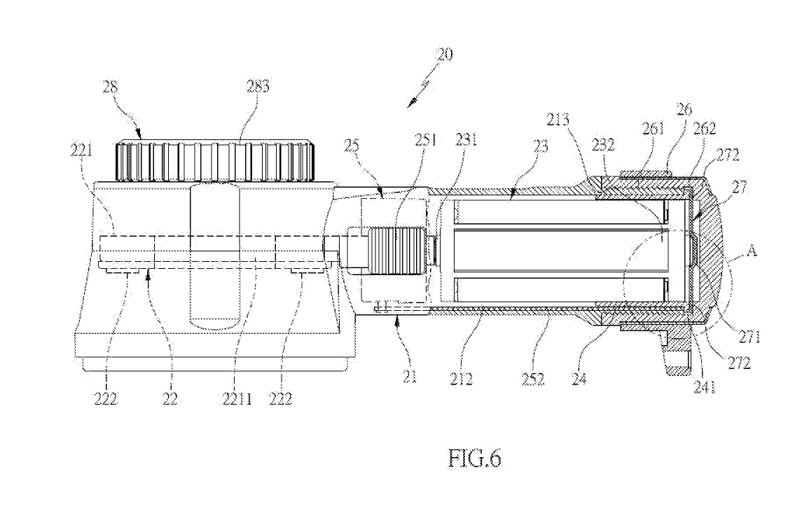

With reference to FIGS. 3-7, an illumination device 20 for a magnifier according to a preferred embodiment of the present invention comprises: a body 21, a light emitting assembly 22, a battery assembly 23, an electricity conducting sleeve 24, a power switch 25, a cover 26, an electric disc 27, and a convex lens assembly 28.

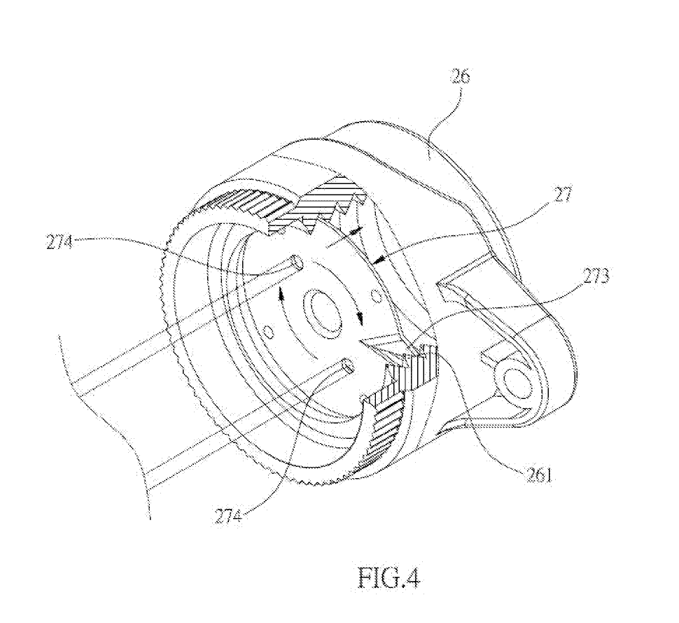

The body 21 is hollow and includes a first accommodating portion 211 defined in a front end thereof, a second accommodating portion 212 extending outwardly from the front end thereof, and a first screwing section 213 arranged on an outer wall of a rear end thereof. The light emitting assembly 22 is connected with the front end of the body 21 and includes a holder 21 disposed in the first accommodating portion 211 of the body 21, a through orifice 2211 defined on a central position of the holder 221, plural illuming elements 222 (such as LED elements) arranged around the through orifice 2211, wherein the plural LED elements 222 are series connected or parallelly connected together, and each of the plural LED elements 222 has a first electricity contact point (not shown) and a second electricity contact point (not shown) electrically connected with the first electricity contact point. The second accommodating portion 212 of the body 21 accommodates a first electrode 231 and a second electrode 232 of the battery assembly 23, and the second accommodating portion 212 of the body 21 fits with the electricity conducting sleeve 24, the electricity conducting sleeve 24 has a rib 241 extending out of the rear end of the body 21. The first electrode 231 of the battery assembly 23, the electricity conducting sleeve 24, and the first electricity contact point and the second electricity contact point of the each LED element 222 of the light emitting assembly 22 are electricity connected with a switching button 251 of the power switch 25, wherein the first electrode 231 of the battery assembly 23 is electrically connected with the first electricity contact point of the each LED element via the power switch 25. The power switch 25 includes an electric guiding piece 252 for electrically connecting with the electricity conducting sleeve 24, such that the electricity conducting sleeve 24 electrically couples with the second electricity contact point of the each LED element 222 via the power switch 25, and the each LED 222 is controlled by the power switch 25 to power on/off. The cover 26 is joined with the rear end of the body 21 and includes a second screwing section 261 arranged on an inner wall thereof to screw with the first screwing 213 of the body 21. The cover 26 also includes a receiving groove 262 defined therein to receive the electric disc 27, and a diameter of the receiving groove 262 is greater than that of the second screwing section 261. The electric disc 27 includes a first electric transmitting portion 271 formed in a recess shape on a central position thereof to contact with the second electrode 232 of the battery assembly 23, and the electric disc 27 also includes plural second electric transmitting portions 272 stamped around the first electric transmitting portion 271 to contact with the rib 241 of the electricity conducting sleeve 24, wherein each of the plural second electric transmitting portions 272 is formed in a protrusion shape. In this embodiment, the electric disc 27 further includes a guide portion 273 formed on a peripheral side thereof to correspond to the second screwing section 261 of the cover 26 and includes plural rotating portions 274 defined beside the first electric transmitting portion 271, wherein each of the plural rotating portions 274 is a through hole, and the electric disc 27 is rotated by inserting a tool into the each rotating portion 274 and rotating the each rotating portion 274, hence the guide portion 273 of the electric disc 27 rotates into the receiving groove 262 of the cover 26 along the second screwing section 261, thus limiting the electric disc 27 by ways of the second screwing section 261 (as shown in FIG. 4). Thereafter, the first screwing section 213 of the body 21 is screwed into the cover 26 so that the first electric transmitting portion 271 of the electric disc 27 contacts with the second electrode 232 of the battery assembly 23, and the plural second electric transmitting portions 272 contact with the rib 241 of the electricity conducting sleeve 24, hence the plural LED elements 222 of the light emitting assembly 22 emit lights stably after turning on the power switch 25. Preferably, the convex lens assembly 28 is fixed in the first accommodating portion 211 of the body 21 and includes a plurality of convex lens 281, a spaced ring 282 for spacing the plurality of the convex lens 281, and a locking loop 283 for locking the convex lens assembly 28 in the first accommodating portion 211 of the body 21, such that objects are viewed clearly by using the plurality of convex lens 281.

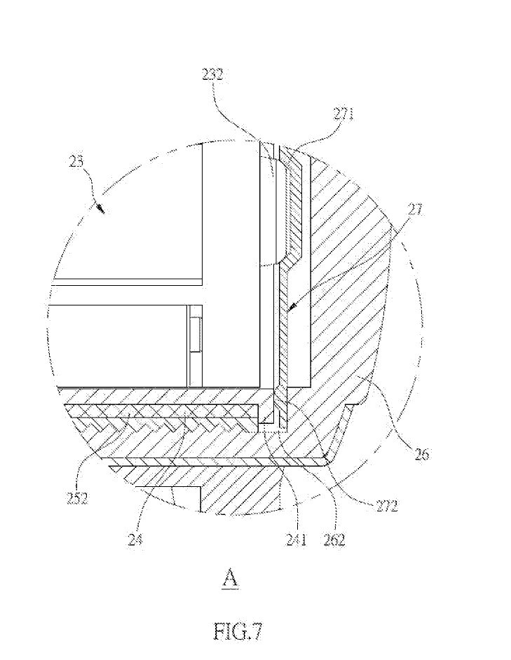

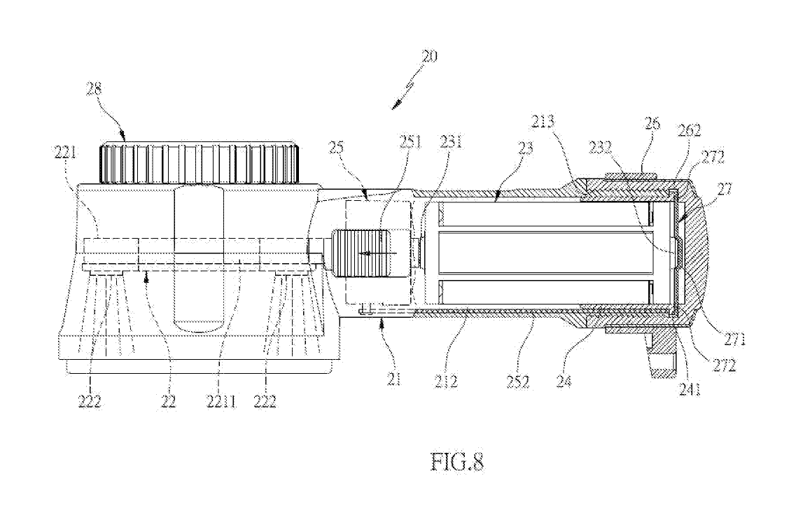

Referring to FIGS. 7 and 8, in operation, the switching button 251 of the power switch 25 is pushed forward to electrically conduct the light emitting assembly 22, the battery assembly 23, the electricity conducting sleeve 24, the power switch 25, and the electric disc 27, such that the battery assembly 23 drives the plural LED elements 222 of the light emitting assembly 22 to emit the lights, thus viewing the objects clearly by using the convex lens assembly 28 and the through orifice 2211 of the holder 221 of the light emitting assembly 22. Preferably, the plural second electric transmitting portions 272 of the electric disc 27 contact with the rib 241 of the electricity conducting sleeve 24 to avoid power failure and a damage of the electricity conducting sleeve 24.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An illumination device for a magnifier comprising:
a body;
a light emitting assembly connected with a front end of the body and including plural LED elements arranged therein, each of the plural LED elements having a first electricity contact point and a second electricity contact point;
a battery assembly accommodated in the body and including a first electrode and a second electrode, the first electrode electrically connecting with the first electricity contact point of the light emitting assembly;
an electricity conducting sleeve fitting with a rear end of the body and electrically connected with the second electrode of the light emitting assembly, and the electricity conducting sleeve including a rib extending out of the rear end of the body;
a cover joined with the rear end of the body;
an electric disc received in the cover and including a first electric transmitting portion for contacting with the second electrode of the battery assembly, the electric disc also including plural second electric transmitting portions arranged around the first electric transmitting portion to contact with the rib of the electricity conducting sleeve.

2. The illumination device for the magnifier as claimed in claim 1, wherein the body is hollow and includes a first accommodating portion defined in the front end thereof, and the body also includes a second accommodating portion extending outwardly from the front end thereof.

3. The illumination device for the magnifier as claimed in claim 1, wherein the body further includes a first screwing section arranged on an outer wall of the rear end thereof, and the cover includes a second screwing section arranged on an inner wall thereof to screw with the first screwing of the body.

4. The illumination device for the magnifier as claimed in claim 1, wherein, wherein the cover also includes a receiving groove defined therein to receive the electric disc, and a diameter of the receiving groove is greater than that of the second screwing section.

5. The illumination device for the magnifier as claimed in claim 4, wherein the electric disc further includes a guide portion formed on a peripheral side thereof to correspond to the second screwing section of the cover and includes plural rotating portions defined beside the first electric transmitting portion.

6. The illumination device for the magnifier as claimed in claim 1, wherein the light emitting assembly includes a holder disposed in the front end of the body, a through orifice defined on a central position of the holder, and plural illuming elements arranged around the through orifice.

7. The illumination device for the magnifier as claimed in claim 6, wherein each of the plural illuming elements is a LED element.

8. The illumination device for the magnifier as claimed in claim 1, wherein the first electrode of the battery assembly, the electricity conducting sleeve, and the first electricity contact point and the second electricity contact point of the each illuming element of the light emitting assembly are electricity connected with a switching button of the power switch, the first electrode of the battery assembly is electrically connected with the first electricity contact point of the each illuming element via the power switch, and the power switch includes an electric guiding piece for electrically connecting with the electricity conducting sleeve.

9. The illumination device for the magnifier as claimed in claim 1, wherein the first electric transmitting portion of the electric disc is formed in a recess shape, and each of the plural second electric transmitting portions is formed in a protrusion shape.

10. The illumination device for the magnifier as claimed in claim 1, wherein the body further includes the convex lens assembly fixed in the front end of the body, and the convex lens assembly includes a plurality of convex lens, a spaced ring for spacing the plurality of the convex lens, and a locking loop for locking the convex lens assembly in the front end of the body.
